(19) United States
(12) Patent Application Publication
(10) Pub. No.: US 2024/0399661 A1
(43) Pub. Date: Dec. 5, 2024

(54) ADDITIVE MANUFACTURING TECHNOLOGY FOR CURVED FIBER COMPOSITE PARTS

(71) Applicants: Mohanad Idrees, Lansdowne, PA (US); Giuseppe Raffaello Palmese, Hainesport, NJ (US); Nicolas Javier Alvarez, Drexel Hill, PA (US)

(72) Inventors: Mohanad Idrees, Lansdowne, PA (US); Giuseppe Raffaello Palmese, Hainesport, NJ (US); Nicolas Javier Alvarez, Drexel Hill, PA (US)

(21) Appl. No.: 18/679,014

(22) Filed: May 30, 2024

Related U.S. Application Data
(60) Provisional application No. 63/505,437, filed on Jun. 1, 2023.

(51) Int. Cl. B29C 64/245; B29C 64/124; B29K 33/00; B29K 75/00; B29K 105/00; B29K 105/08; B29K 309/08

(52) U.S. Cl. CPC B29C 64/245; B29C 64/124; B29K 2033/08; B29K 2075/00; B29K 2105/0094; B29K 2105/0845; B29K 2309/08

(57) ABSTRACT

A reconfigurable tool suitable for use with a stereolithographic printer for composite manufacturing of a shaped object, comprising a bundle of a plurality of light transmitting rods each having a longitudinal axis, a diameter and first and second end surfaces, said rods being arranged in parallel, and each said rod being independently movable in an axial direction relative to other said rods when a shaping surface having a shape is pressed against the first end surfaces of the rods to thereby position the second end surfaces of the rods to form a negative relief of the shape of the shaping surface, and a releasable locking mechanism for maintaining the rods in the positions that forms the negative relief. Also, a method for printing a shaped object having a shape of a shaped surface using a stereolithographic printer in combination with the reconfigurable tool.

### CROSS REFERENCE TO RELATED APPLICATIONS

This application claims the benefit of U.S. Provisional Application No. 63/505,437 filed on Jun. 1, 2023, the disclosure of which is hereby incorporated by reference in its entirety as if set forth fully herein.

### STATEMENT OF GOVERNMENT INTEREST

This invention was made with government support under Contract No. 960117-3662 awarded by the US Army Research Lab. The government has certain rights in the invention.

### BACKGROUND OF THE INVENTION

Additive manufacturing (AM) has evolved to include many different techniques and processable materials, enabling the prototyping and production of objects with complex geometries via a planar layer-by-layer methodology [1-4]. The two primary AM techniques are: (1) extrusion based techniques, such as fused deposition modeling (FDM) or Fused Filament Fabrication (FFF), and direct ink writing (DIW) [5]-[8], and (2) stereolithographic techniques denoted by their light source, i.e., liquid crystal display (LCD), Stereolithography (SLA), and Digital Light Processing (DLP) [9]. Each method has its pros and cons and list of printable materials. For example, stereolithographic techniques produce parts with high fidelity and mechanical properties (on par with traditional manufacturing), but are limited to thermoset resins with sufficiently low viscosity.

Regardless of printer technology, one significant drawback of all “plastic” printers is that unreinforced parts are significantly weaker than their metallic counterparts [10]. In fact, there are very few, if any, high performance applications that rely on unreinforced polymeric materials. Fiber reinforcement (glass or carbon) increases the stiffness of plastic parts by an order of magnitude, such that the stiffness-to-weight ratio exceeds that of metal parts [11]. The poor mechanical properties of neat plastic is one reason that polymer AM techniques are limited to fast prototyping and are rarely used for end use parts. For AM to be used for high performance applications, it is essential that methods capable of reinforcement printing are developed. However, developing such a technique faces two major hurdles: (1) the difficulty of fiber incorporation into the neat resins, and (2) the planar nature of AM, e.g., parts are produced by stacking flat layers, which methodology is not suitable for curved composite structures.

Fiber reinforced composite parts are traditionally manufactured using resin transfer molding (RTM) methods, which are capable of producing composite parts with complex 3D geometries, high fidelity, and reproducibility. However, unlike AM technologies, RTM methods lack versatility due to their need for expensive tooling, i.e., molds [12]-[14]. This makes composite manufacturing significantly more labor intensive than traditional top-down manufacturing approaches. There is a significant potential for AM methods to decrease the cost and complexity of composite manufacturing.

At present, there are only two methods proposed to manufacture high volume fraction glass/carbon composite parts through additive manufacturing: automated fiber placement (AFP), and automated layup (AL). AFP has been used in the manufacturing of aerospace parts since the early 1980s, e.g. Boeing's Chinook Helicopter. The AFP robotic head can lay and consolidate material on a flat or curved substrate [15]. Though the technique is reliable and produces high-end parts, it has significant shortcomings. For example, AFP requires complex hardware, and a prepreg feed [16]. Additionally, AFP requires the presence of a solid substrate, i.e., mold, for efficient and successful tape laying and fiber consolidation. AL techniques were recently demonstrated by Idrees et al. involving the consolidation of single fiber mat layers using standard stereolithographic printers. However, as in all AL methods, the parts are restricted to flat composite layers, and therefore require complicated mat cutting protocols that take into account the vectorization (i.e. slicing) of the part. Furthermore, these parts require significant post-processing such as polishing and reshaping. Overall, both AFP and AL methods fall short of being able to produce complex curved composite parts that are comparable to those fabricated by RTM methods.

### SUMMARY OF THE INVENTION

The following sentences may be used to describe embodiments of the present invention.
1. In a first aspect, the present invention relates to a reconfigurable tool suitable for use with a stereolithographic printer for composite manufacturing of a shaped object, comprising:
a bundle of a plurality of light transmitting rods each having a longitudinal axis, a diameter and first and second end surfaces, said rods being arranged in parallel, and each said rod being independently movable in an axial direction relative to other said rods when a shaping surface having a shape is pressed against the first end surfaces of the rods to thereby position the second end surfaces of the rods to form a negative relief of the shape of the shaping surface, and a releasable locking mechanism for maintaining the rods in the positions that forms the negative relief.
2. The reconfigurable tool of sentence 1, wherein each of the first and second end surfaces of the rods may have a diameter of from about 0.5 mm to about 3 mm, or from about 0.5 mm to about 2 mm, or from about 1 mm to about 2 mm, or about 1.58 mm.
3. The reconfigurable tool of any one of sentences 1-2, wherein the rods may have a length of from about 10 mm to about 100 mm, or from about 20 mm to about 70 mm, or from about 30 mm to about 50 mm.
4. The reconfigurable tool of any one of sentences 1-3, wherein the rods may be transparent, such that when a source of light is applied to the rods the second end surfaces of the rods have a power density of greater than 0.2 mW/cm², or greater than 0.5 mW/cm², or about 0.7 mW/cm², wherein the power density is measured by an ILT 2400 radiometer (International Light Technologies) with a sensor having a 320-450 nm range.
5. The reconfigurable tool of any one of sentences 1-4, wherein the locking mechanism may be a mechanical clamp, or pneumatic clamp, or a rope, or an elastic band that holds the bundle of rods together.
6. The reconfigurable tool of any one of sentences 1-5, wherein the rods may have a square or rectangular cross-section.
7. The reconfigurable tool of any one of sentences 1-6, wherein the rods may have a mechanical strength in the axial direction of from about 50 MPa to about 150 MPa, or from about 100 MPa to about 130 MPa, or less than about 120 MPa.
8. The reconfigurable tool of any one of sentences 1-7, wherein the locking mechanism may be configured to maintain the rods in place when a pressure of from about 0.01 to less than 120 MPa, or from about 0.02 MPa to about 50 MPa, or from about 0.01 to about 5 MPa is exerted in an axial direction on the second ends of the rods.
9. In a second aspect, the present invention may relate to a method for composite manufacturing of a shaped object using a stereolithographic printer in combination with the reconfigurable tool of any one of sentences 1-8, said method may include: pressing a shaping surface having a shape against at least some of the first ends of the rods to position the second ends of the rods in an axial direction to form a negative cavity relief that corresponds to the shape of the shaped surface, locking the rods in the positions forming the negative cavity relief, compressing at a pressure of less than 120 MPa, or from about 0.01 MPa to less than 120 MPa, or from about 0.01 MPa to about 50 MPa, or from about 0.01 to about 5 MPa a fiber-resin composite material against at least some of the second ends of the rods, and curing the fiber-resin composite material.
10. The method of sentence 9, wherein the stereolithographic printer may be selected from the group consisting of a liquid-crystal (LCD) printer and a digital light processing (DLP) printer.
11. The method of any one of sentences 9-10, wherein the curing step may include curing with light such as ultraviolet light.
12. The method of any one of sentences 9-11, wherein the fiber-resin composite material may have a viscosity of from about 200 cP to about 1000 cP, or from about 400 cP to about 600 cP, or about 450 cP to about 550 cP, as measured by a Brookfield rheometer at room temperature.
13. In a third aspect, the present invention may relate to a composite formed by the method of any one of sentences 9-12.
14. In a fourth aspect, the present invention may relate to a system for composite manufacturing of a shaped object a composite comprising:
a stereolithographic printer,
a reconfigurable tool suitable for use with the stereolithographic printer for composite manufacturing of the shaped object, the reconfigurable tool including:
   a bundle of a plurality of light transmitting rods each having a longitudinal axis, a diameter and first and second end surfaces, said rods being arranged in parallel, and each said rod being independently movable in an axial direction relative to other said rods when a shaping surface having a shape is pressed against the first end surfaces of the rods to thereby position the second end surfaces of the rods to form a negative relief of the shape of the shaping surface, and
   a releasable locking mechanism for maintaining the rods in the positions that forms the negative relief.
15. In a fifth aspect, the present invention may relate to a method for fast casting of a shaped object having a shape of a shaped surface using a stereolithographic printer in combination with the reconfigurable tool of any one of sentences 1-8, said method comprising:
pressing a shaping surface having a shape against at least some of the first ends of the rods to position the second ends of the rods in an axial direction to form a negative cavity relief that corresponds to the shape of the shaped surface,
locking the rods in the positions forming the negative cavity relief,
compressing a material against at least some of the second ends of the rods, and curing the material.
16. In a sixth aspect, the present invention may relate to a method for printing a shaped object having a shape of a shaped surface using a stereolithographic printer in combination with the reconfigurable tool of any one of sentences 1-8, said method comprising:
pressing a shaping surface having a shape against at least some of the first ends of the rods to position the second ends of the rods in an axial direction to form a negative cavity relief that corresponds to the shape of the shaped surface,
locking the rods in the positions forming the negative cavity relief,
compressing a resin material against at least some of the second ends of the rods, and
curing the resin material.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows a schematic of the method of curved parts manufacturing according to the present invention. The top left image of FIG. 1 shows a schematic of the reconfigurable tool for composite manufacturing.

FIG. 2A shows the reconfigurable tool.

FIG. 2B shows the manufacturing steps with the tool affixed to the printer.

FIG. 3 shows a variety of possible curvatures parts.

FIG. 4A shows a CAD model of the curvature resolution of the resin part.

FIG. 4B shows a glass fiber composite showing the curvature resolution.

FIG. 4C shows a composite part profile of the curvature resolution.

FIG. 5A shows in the top image a test specimen and its cross section in the bottom image which were tested in a short beam shear (SBS) test.

FIG. 5B shows the results of the short beam shear test.

### DETAILED DESCRIPTION OF THE INVENTION

Herein is disclosed a novel additive manufacturing technology that combines aspects of resin transfer molding (RTM) with the versatility of additive manufacturing (AM). This method involves the use of a transparent reconfigurable tool that allows for mold printing, stamping, and consolidation/replication. The method is exemplified by producing curved glass fiber composite parts with a range of different curvatures. The reconfigurable tool offers a flexible approach to fabrication of curved composite structures with intricate details using standard stereolithographic LCD and DLP printers, and enables fast and cost-effective production of high volume fraction fiber-reinforced parts.

Manufacturing curved composite structures is a challenging process that requires costly tools. The present method can be used to manufacture nonplanar (curved) glass fiber composite parts using a transparent, reconfigurable tool mounted on an LCD printer. The tool comprises small transparent rods actuated by pushing a printed neat resin part against the tool to generate a curved surface. The resulting surface is locked in place; a curved composite is then made by sandwiching a fiber-wetted resin between the tool and the part, followed by applying pressure and UV light. The fabrication of a range of different curved geometries with features as small as 5 mm are demonstrated. The tool offers an efficient method to rapidly prototype and replicate fiber-reinforced parts.

### EXAMPLES

Bisphenol A glycidyl methacrylate (BisGMA), ethoxylated bisphenol A dimethacrylate (BisEMA) and 1,6-hexanediol dimethacrylate (HDMMA) were purchased from Esstech, Inc. Phenylbis(2,4,6-trimethylbenzoyl) phosphine oxide (PPO) was supplied by Sigma Aldrich and used as received. BisGMA, BisEMA, and HDMMA were mixed at ratio of 3:3:2 to form the DA-2 resin and 0.7 wt % percent PPO photoinitiator was added. Tenacious is a urethane acrylate resin purchased from Siraya Tech. Jianwei et al. have previously published information on the composition and characteristics of DA-2 [21]. E-glass fabric (plain weave) with an areal density of 7.5 oz/yd² and a 0.01 inch thickness was purchased from FiberGlast developments Corp.

### Methods

Light intensity and resin printing—The light intensity was measured using an ILT 2400 radiometer (International Light Technologies) with a 320-450 nm range sensor. The resin parts were printed using an Anycubic photon mono SE LCD printer with a power density of 3.0 mW/cm². The tool's top surface distance from the LCD surface varied from 45 mm to 85 mm, with a power density at the top of the tool varying from 0.7 mW/cm²-0.77 mW/cm², and the power decay was approximately 70%.

### Process Description

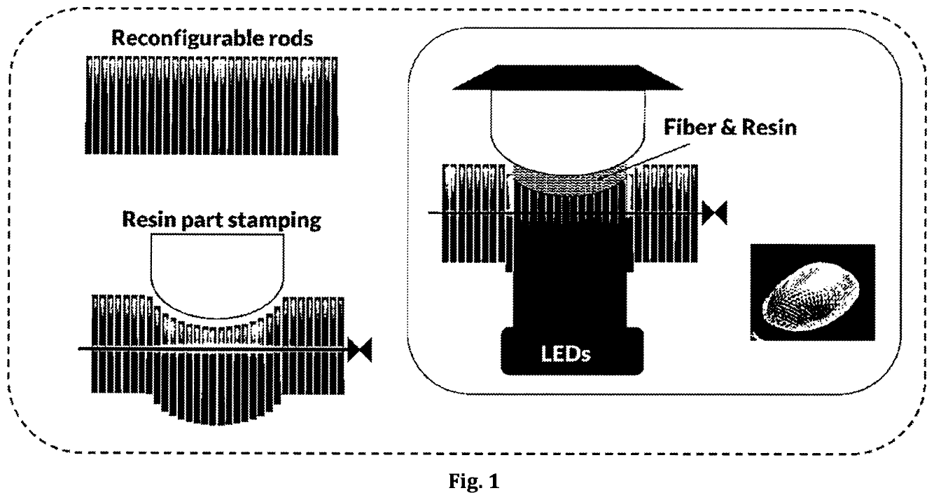

The tool is composed of a bundle of transparent glass/plastic rods that are held together via a custom made clamp. See FIG. 1. The tool may press against the rods at a force of less than 150 N. The pressure on the rods is adjustable, such that at high pressure, for example at a pressure of less than 120 MPa, or from about 0.01 MPa to less than 120 MPa, or from about 0.01 MPa to about 50 MPa, or from about 0.01 to about 5 MPa for example, the rods act like a solid transparent resin vat for printing a positive relief mold. At low pressure, for example at a pressure of from about 0.01 MPa to about 50 MPa, or from about 0.01 to about 5 MPa the rods are capable of sliding past each other and conforming around the printed mold to create a negative cavity relief. This step is followed by increasing the pressure via the clamp to prevent movement of the rods, i.e., locking the negative relief. The relief now plays the role of a curved resin vat where fiber and resin can be added. The positive relief is used to apply pressure on the fiber wetted resin against the negative relief formed by the rods. Curing to form the part is initiated by UV light that passes through the clear rods. In the same manner, more fiber layers can be added to make thicker parts or to add resin rich layers. Finally, the part is removed for further post-processing. The tool is affixed to a commercial LCD printer. Any cubic photon mono SE. Protective polyethylene films are used to prevent resin leaks on the rods and the curing of composite on the resin object.

### Laser Profilometer and Part Profile Measurements—

Part height profile was investigated using a laser profilometer consisting of a high precision xy-stage model V-731 and a high accuracy small spot laser (LK-G32). The profile scanning was carried out at a speed of 10 mm/s and a resolution of 100.

### Short Beam Shear

DA-2 glass fiber specimens with a 5.9 mm thickness and a radius of curvature of 70 mm were reproduced. The short beam shear tests were carried out as per ASTM D2344/D2344M-16 with a span to thickness ratio of 5:1. The test was carried out at 1.0 mm/min on a servo-hydraulic Instron apparatus, equipped with 25 kN load cell.

Table 1 shows the curved beam Dimensions.

TABLE 1
SBS test specimen

| | |
|---|---|
| Thickness (mm) | 5.9 ± 0.2 |
| Width (mm) | 12.6 ± 0.3 |
| Span length (mm) | 30 |

### Results and Discussion

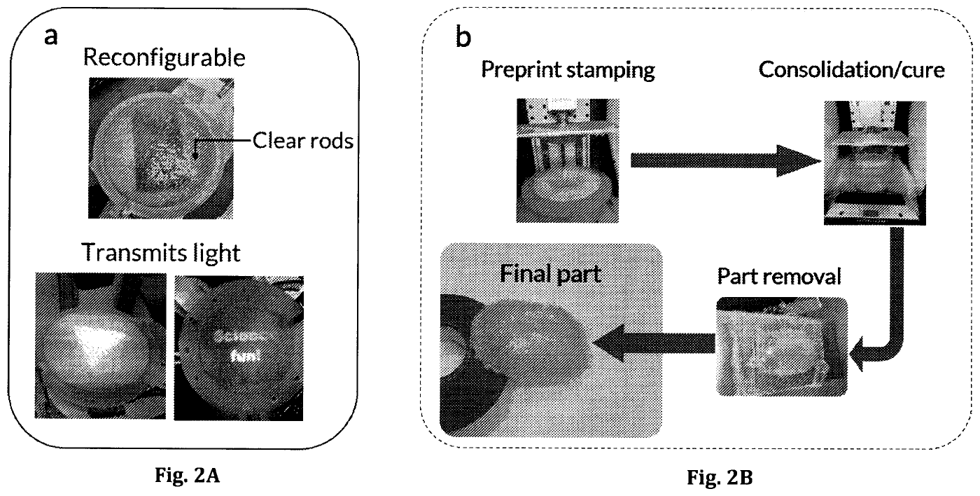

The tool's functionality relies on its reconfigurability and light transmittance. FIG. 2 shows the tool, and its use in the composite manufacturing process. The top image in FIG. 2A shows the reconfigurable tool. The transparent bundle of rods is held together by a holder (clamp) and a curved object is placed underneath the rods is shown in FIG. 2A. In the bottom portion of FIG. 2A, two examples are shown that exhibited good light transmittance. On the left, light is projected from underneath with a triangular object and, in this case, the text, “Science fun!” can be clearly seen. This high degree of light transmittance is needed for composite photocuring. The degree of light transmittance was determined by measuring the power density of light transmitted through the rods (on the top surface of the rods). Using a light source power density of 3 mW/cm², the power density on the rods top surface (where curing occurs) was about 0.7 mW/cm². The power density was measured using an ILT 2400 radiometer (International Light Technologies) with a 320 nm-450 nm range sensor. A minimum power density of 0.5 mW/cm² should be applied to the top surface of the rods.

Suitable examples of the locking mechanism may include a clamp mechanism; a pneumatic lock mechanism comprising a pneumatic actuator and a locking element, wherein the pneumatic actuator is configured to generate a pneumatic force to engage the locking element with the rods, securing them in place; a rope lock mechanism, comprising a rope or cord and a locking element, wherein the rope or cord is configured to be wound around the rods and the locking element is configured to secure the rope or cord in place, maintaining tension and preventing the rods from moving; and an elastic band lock mechanism, comprising an elastic band and a locking element, wherein the elastic band is configured to be stretched and secured around the rods with a tension using the locking element, preventing the rods from shifting or separating

FIG. 2B depicts all stages of the process described in FIG. 1. FIG. 2B shows a resin part that is used to create curvature on the tool surface, followed by the addition of fiber and resin as they appear on the plastic bag. The building platform is then moved down to apply pressure followed by UV exposure. FIG. 2B (bottom) shows the composite part attached to the building platform and the curved composite part after removal from the device. Polyethylene bags were used to protect the tool from resin and to facilitate composite removal from the resin part. Composites with a variety of different curvatures and features were made using this process.

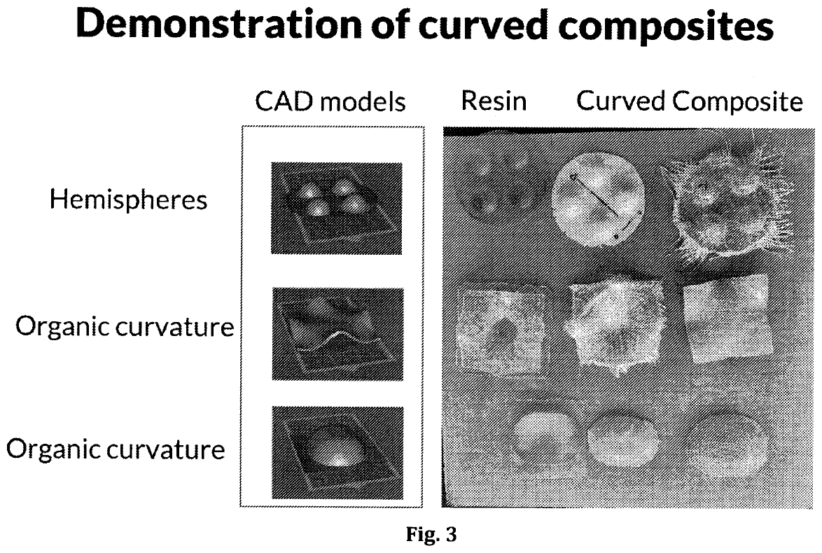

Hemispheres are one of the most challenging shapes to achieve in composite manufacturing due to the significant bending and flexure of the fiber mat that is required. Thus, four hemispherical features with different radii of curvature were chosen for testing. The CAD models are shown in FIG. 3 (left side). The 1 left side (first column) shows the printed neat resin parts used to create the negative relief using the reconfigurable glass rods. The second and third columns show the resulting glass fiber composite structures, with a single mat and multiple fiber mats, respectively. The printed parts were measured using a profilometer to determine the resolution of the method.

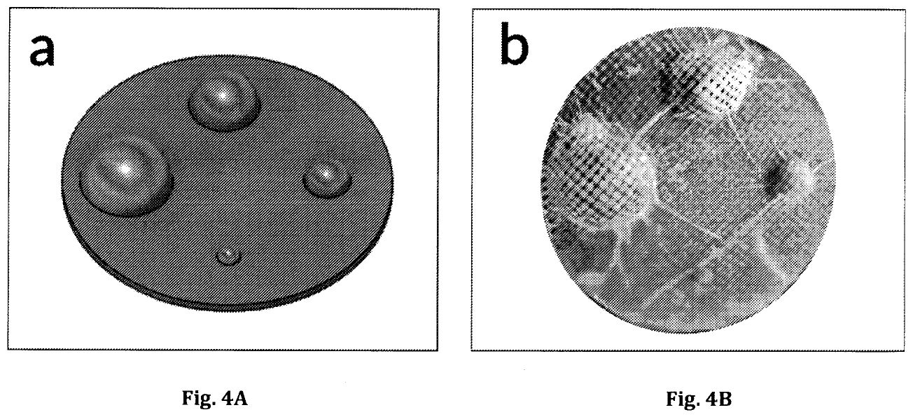

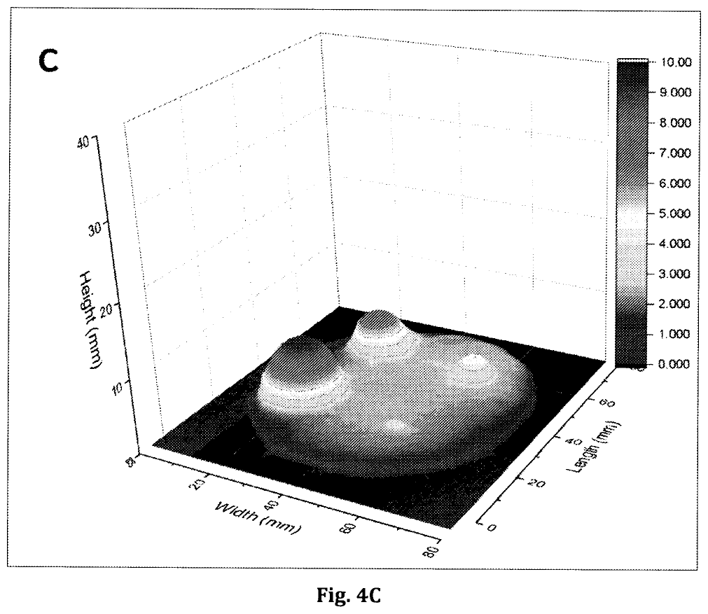

The tool resolution, e.g. the minimum achievable feature size, is an important consideration for the parts' dimensional accuracy. The exemplified tool was made of rods having 1.58 mm diameters. While rods with smaller diameters might provide a better resolution, the increased contact area between rods might increase friction and lead to a bad stamping of the curvature. To assess the tool's resolution, the profile of a composite resin part containing four hemispheres with diameters of 5 mm, 10 mm, 15 mm, and 20 mm, respectively, was investigated. The resin part model and the composite parts are shown in FIGS. 4a and 4b. The composite part profile was scanned using a high-accuracy laser profilometer. FIG. 4b shows the profilometer results in which four raised bumps are seen. The 10 mm, 15 mm, and 20 mm diameter hemispheres maintained distinguishable hemispherical shapes. There were slight issues at the hemisphere-flat surface edge. The raised areas can be attributed to the drapability of the mat, and creases in the plastic film.

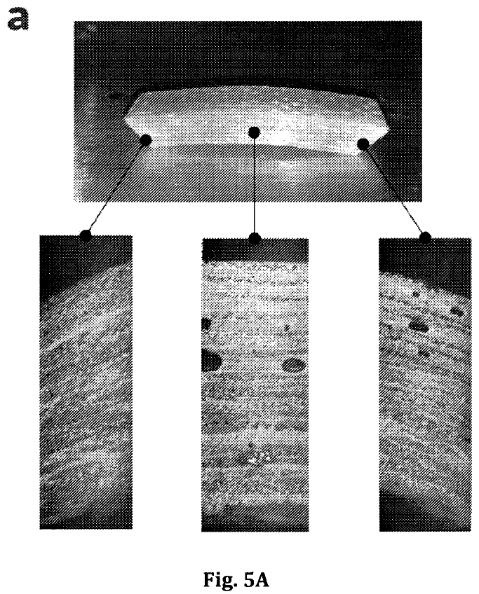

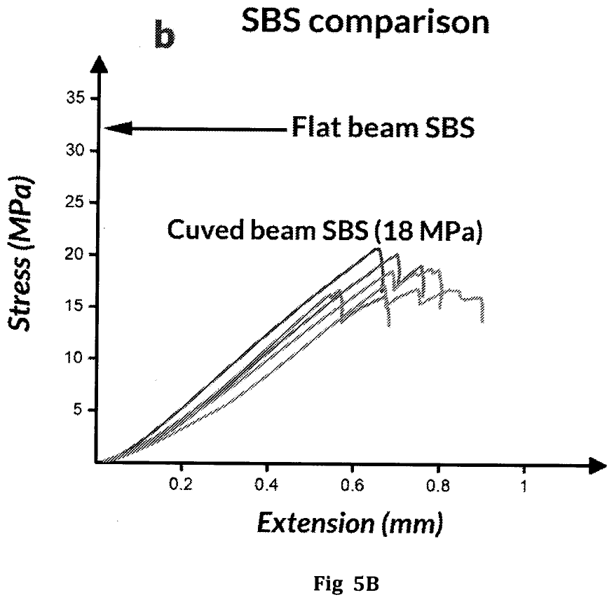

After demonstrating the ability to achieve relatively small features as discussed above, the integrity of the parts made using this technique was determined. The short beam shear (SBS) test was used to test the resistance of the composite parts to interlaminar stresses. A curved thick composite part was manufactured as per ASTM standards. A long curved panel was made and then cut to shape. FIG. 5A shows an image of the curved part along with cross-sectional images of the parts at different points. Although the curved shape was achieved, manufacturing defects such as voids were seen in the cross-sections, indicating a need for an increased consolidation force. The specimens had a short beam shear strength of ˜18 MPa. This short beam shear strength is approximately 50% lower than the short beam shear strength of the flat part [22]. Due to the geometrical variation, the state of interlaminar stresses in a flat specimen is different than in a curved specimen; and, as a result, this relatively low short beam shear strength was expected for the curved specimen [16].

In summary, a suitable method for the manufacture of curved composite structures was demonstrated using a transparent reconfigurable tool that allows for light transmittance and photo curing of glass-fiber impregnated resin. Complex curved features were successfully created. A hemisphere, which is known to be the most difficult structure to form, was successfully made. In addition, parts with small features and good interlaminar strength were fabricated. The tool eliminates the need for molds and provides a new approach to rapidly prototype fiber-reinforced composite parts with additive manufacturing.

### REFERENCES

ADDIN Mendeley Bibliography CSL_BIBLIOGRAPHY [1] G. D. Goh, Y. L. Yap, S. Agarwala, and W. Y. Yeong, “Recent Progress in Additive Manufacturing of Fiber Reinforced Polymer Composite,” Adv. Mater. Technol., vol. 4, no. 1, pp. 1-22, January 2019, doi: 10.1002/admt.201800271.
[2] X. Wang, M. Jiang, Z. Zhou, J. Gou, and D. Hui, “3D printing of polymer matrix composites: A review and prospective,” Compos. Part B Eng., vol. 110, pp. 442-458, 2017, doi: 10.1016/j.compositesb.2016.11.034.
[3] R. Hashemi Sanatgar, C. Campagne, and V. Nierstrasz, “Investigation of the adhesion properties of direct 3D printing of polymers and nanocomposites on textiles: Effect of FDM printing process parameters,” Appl. Surf. Sci., 2017, doi: 10.1016/j.apsusc.2017.01.112.
[4] S. J. Leigh, R. J. Bradley, C. P. Purssell, D. R. Billson, and D. A. Hutchins, “A Simple, Low-Cost Conductive Composite Material for 3D Printing of Electronic Sensors,” PLoS One, vol. 7, no. 11, pp. 1-6, 2012, doi: 10.1371/journal.pone.0049365.
[5] O. A. Mohamed et al., “Experimental investigation of the influence of fabrication conditions on dynamic viscoelastic properties of PC-ABS processed parts by FDM process,” IOP Conf. Ser. Mater. Sci. Eng., vol. 149, no. 1, p. 012122, 2016, doi: 10.1088/1757-899X/149/1/012122.
[6] M. Alzahrani, “Modification of Recycled Poly(ethylene terephthalate) for FDM 3D-Printing Applications by,” 2017.
[7] M. Hossain, J. Ramos, D. Espalin, M. Perez, and R. Wicker, “Improving Tensile Mechanical Properties of FDM-Manufactured Specimens via Modifying Build Parameters,” Utwired.Engr. Utexas.Edu, pp. 380-392, 2013, [Online]. Available: http://utwired.engr.utexas.edu/lff/symposium/proceedingsarchive/pubs/manuscripts/2013/2013-30-hossain.pdf.
[8] C. Richter, S. Schmuelling, A. Ehrmann, and K. Finsterbusch, “FDM printing of 3D forms with embedded fibrous materials,” Des. Manuf. Mechatronics (icdmm 2015), pp. 961-969, 2016, doi: 10.1142/9789814730518_0112.
[9] A. Bagheri and J. Jin, “Photopolymerization in 3D Printing,” ACS Appl. Polym. Mater., vol. 1, no. 4, pp. 593-611, 2019, doi: 10.1021/acsapm.8b00165.
[10] P. K. Mallick, Fiber-Reinforced Composites: Materials, Manufacturing, and Design, 3rd Editio., vol. 19. Boca Raton: CRC Press, 2007.
[11] P. Parandoush, C. Zhou, and D. Lin, “3D Printing of Ultrahigh Strength Continuous Carbon Fiber Composites,” Adv. Eng. Mater., vol. 21, no. 2, pp. 1-8, 2019, doi: 10.1002/adem.201800622.
[12] M. K. Hossain, M. E. Hossain, M. W. Dewan, M. Hosur, and S. Jeelani, “Effects of carbon nanofibers (CNFs) on thermal and interlaminar shear responses of E-glass/polyester composites,” Compos. Part B Eng., vol. 44, no. 1, pp. 313-320, 2013, doi: 10.1016/j.compositesb.2012.05.006.
[13] B. Beylergil, M. Tanoğlu, and E. Aktaş, “Experimental and statistical analysis of carbon fiber/epoxy composites interleaved with nylon 6,6 nonwoven fabric interlayers,” J. Compos. Mater., vol. 54, no. 27, pp. 4173-4184 Nov. 2020, doi: 10.1177/0021998320927740.
[14] Z. Fan, M. H. Santare, and S. G. Advani, “Interlaminar shear strength of glass fiber reinforced epoxy composites enhanced with multi-walled carbon nanotubes,” Compos. Part A Appl. Sci. Manuf., vol. 39, no. 3, pp. 540-554, 2008, doi: 10.1016/j.compositesa.2007.11.013.
[15] J. Frketic, T. Dickens, and S. Ramakrishnan, “Automated manufacturing and processing of fiber-reinforced polymer (FRP) composites: An additive review of contemporary and modern techniques for advanced materials manufacturing,” Addit. Manuf., vol. 14, pp. 69-86, 2017, doi: 10.1016/j.addma.2017.01.003.
[16] Z. Qureshi, T. Swait, R. Scaife, and H. M. El-Dessouky, “In situ consolidation of thermoplastic prepreg tape using automated tape placement technology: Potential and possibilities,” Compos. Part B Eng., vol. 66, pp. 255-267, November 2014, doi: 10.1016/J.COMPOSITESB.2014.05.025.
[17] H. R. D et al., “Method of laying up prepreg plies on contoured tools using a deformable carrier film,” 2013.
[18] B. V. M, S. J. K, R. T. A, H. J. L, R. MARK, and O. TIMOTHY, “Apparatus and methods for forming composite stiffeners and reinforcing structures,” 2010.
[19] B. T. A, F. S. DOUGLAS, H. C. G, and M. A. E, “Method of manufacturing curved composite structural elements,” 2017.
[20] H. R. D, M. A. E, and D. E. P, “Method of manufacturing curved composite structural elements,” 2011.
[21] J. Tu, K. Makarian, N. J. Alvarez, and G. R. Palmese, “Formulation of a Model Resin System for Benchmarking Processing-Property Relationships in High-Performance Photo 3D Printing Applications,” Mater. 2020, Vol. 13, Page 4109, vol. 13, no. 18, p. 419 Sep. 2020, doi: 10.3390/MA13184109.
[22] M. Idrees, A. M. H. Ibrahim, E. Tekerek, A. Kontsos, G. R. Palmese, and N. J. Alvarez, “The effect of resin-rich layers on mechanical properties of 3D printed woven fiber-reinforced composites,” Compos. Part A Appl. Sci. Manuf., vol. 144, p. 106339, May 2021, doi: 10.1016/j.compositesa.2021.106339.

What is claimed is:

1. A reconfigurable tool suitable for use with a stereolithographic printer for composite manufacturing of a shaped object, comprising:
a bundle of a plurality of light transmitting rods each having a longitudinal axis, a diameter and first and second end surfaces, said rods being arranged in parallel, and each said rod being independently movable in an axial direction relative to other said rods when a shaping surface having a shape is pressed against the first end surfaces of the rods to thereby position the second end surfaces of the rods to form a negative relief of the shape of the shaping surface, and
a releasable locking mechanism for maintaining the rods in the positions that forms the negative relief.

2. The reconfigurable tool of claim 1, wherein each of the first and second end surfaces of the rods has a diameter of from about 0.5 mm to about 3 mm.

3. The reconfigurable tool of claim 1, wherein the rods have a length of from about 10 mm to about 100 mm.

4. The reconfigurable tool of claim 1, wherein the rods are transparent, such that when a source of light is applied to the rods the second end surfaces of the rods have a power density of greater than 0.2 mW/cm², wherein the power density is measured by an ILT 2400 radiometer (International Light Technologies) with a sensor having a 320-450 nm range.

5. The reconfigurable tool of claim 1, wherein the locking mechanism is selected from the group consisting of a mechanical clamp, a pneumatic clamp, a rope, and an elastic band that holds the bundle of rods together.

6. The reconfigurable tool of claim 1, wherein the rods have a square or rectangular cross-section.

7. The reconfigurable tool of claim 1, wherein the rods have a mechanical strength in the axial direction of from about 50 MPa to about 150 MPa.

8. The reconfigurable tool of claim 1, wherein the locking mechanism is configured to maintain the rods in place when a pressure of from about 0.01 to less than 120 MPa is exerted in an axial direction on the second ends of the rods.

9. The reconfigurable tool of claim 1, wherein each of the first and second end surfaces of the rods may have a diameter of from about 1 mm to about 2 mm.

10. The reconfigurable tool of claim 1, wherein the rods may be transparent, such that when a source of light is applied to the rods the second end surfaces of the rods have a power density of greater than 0.5 mW/cm², as measured by an ILT 2400 radiometer (International Light Technologies) with a sensor having a 320-450 nm range.

11. The reconfigurable tool of claim 1, wherein the rods have a mechanical strength in the axial direction of from about 100 MPa to about 130 MPa.

12. The reconfigurable tool of claim 1, wherein the locking mechanism may be configured to maintain the rods in place when a pressure of from about 0.02 MPa to about 50 MPa is exerted in an axial direction on the second ends of the rods.

13. A method for composite manufacturing of a shaped object using a stereolithographic printer in combination with the reconfigurable tool of claim 1, said method comprising:
pressing a shaping surface having a shape against at least some of the first ends of the rods to position the second ends of the rods in an axial direction to form a negative cavity relief that corresponds to the shape of the shaped surface,
locking the rods in the positions forming the negative cavity relief,
compressing at a pressure of less than 120 MPa, or from about 0.01 MPa to less than 120 MPa, or from about 0.01 MPa to about 50 MPa, or from about 0.01 to about 5 MPa a fiber-resin composite material against at least some of the second ends of the rods, and
curing the fiber-resin composite material.

14. The method of claim 13, wherein the stereolithographic printer is selected from the group consisting of a liquid-crystal (LCD) printer and a digital light processing (DLP) printer.

15. The method of claim 13, wherein the curing step comprises curing with light such as ultraviolet light.

16. The method of claim 13, wherein the fiber-resin composite material has a viscosity of from about 200 cP to about 1000 cP, as measured by a Brookfield rheometer at room temperature.

17. A composite formed by the method of claim 13.

18. A system for composite manufacturing of a shaped object composite comprising:
a stereolithographic printer,
a reconfigurable tool suitable for use with the stereolithographic printer for composite manufacturing of the shaped object, the reconfigurable tool including:
a bundle of a plurality of light transmitting rods each having a longitudinal axis, a diameter and first and second end surfaces, said rods being arranged in parallel, and each said rod being independently movable in an axial direction relative to other said rods when a shaping surface having a shape is pressed against the first end surfaces of the rods to thereby position the second end surfaces of the rods to form a negative relief of the shape of the shaping surface, and
a releasable locking mechanism for maintaining the rods in the positions that forms the negative relief.

19. A method for fast casting of a shaped object having a shape of a shaped surface using a stereolithographic printer in combination with the reconfigurable tool of claim 1, said method comprising:
pressing a shaping surface having a shape against at least some of the first ends of the rods to position the second ends of the rods in an axial direction to form a negative cavity relief that corresponds to the shape of the shaped surface,
locking the rods in the positions forming the negative cavity relief,
compressing a material against at least some of the second ends of the rods, and
curing the material.

20. A method for printing a shaped object having a shape of a shaped surface using a stereolithographic printer in combination with the reconfigurable tool of claim 1, said method comprising:
pressing a shaping surface having a shape against at least some of the first ends of the rods to position the second ends of the rods in an axial direction to form a negative cavity relief that corresponds to the shape of the shaped surface,
locking the rods in the positions forming the negative cavity relief,
compressing a resin material against at least some of the second ends of the rods, and
curing the resin material.
